(19) United States
(12) Patent Application Publication
(10) Pub. No.: US 2026/0260502 A1
(43) Pub. Date: Sep. 3, 2026

(54) IMAGE RECOGNITION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Peitao HU, Beijing (CN); Mingyuan WANG, Beijing (CN); Lishu LUO, Beijing (CN); Jianlong ZHANG, Beijing (CN); Chao LONG, Beijing (CN); Yi FU, Beijing (CN); Liyue WANG, Beijing (CN)

(21) Appl. No.: 19/156,301

(22) PCT Filed: Feb. 7, 2024
(86) PCT No.: PCT/CN2024/076566

§ 371 Date: Aug. 13, 2025

(30) Foreign Application Priority Data
Feb. 13, 2023 (CN) 202310151604.5

(51) Int. Cl. G06V 20/62

(52) U.S. Cl. CPC G06V 20/625; G06V 2201/07

(57) ABSTRACT

An image recognition method and apparatus, an electronic device and a storage medium are provided. The image recognition method includes: obtaining a first instruction which is configured to indicate a first feature of an item; obtaining an environment image, and detecting the environment image based on the first instruction to obtain a first recognition object and a second recognition object, wherein the first recognition object is an image element characterizing the first feature, and the second recognition object is a text element characterizing the first feature; and recognizing a first item with the first feature according to the first recognition object and the second recognition object.

The present application claims the priority of the Chinese Patent Application No. 202310151604.5 filed on Feb. 13, 2023, the disclosure content of which is incorporated herein by reference in its entirety and constitutes a part of the present application.

### TECHNICAL FIELD

The embodiments of the present disclosure relate to an image recognition method and apparatus, an electronic device, and a storage medium.

### BACKGROUND

Image recognition technologies refer to the technologies that utilize a computing device to analyze and understand an image, to recognize a target object or item in the image. The image recognition technologies are widely used in many fields such as security detection and automatic navigation. For example, in a smart terminal designed for visually impaired people, an image recognition technology is used to collect an environment image and perform image recognition, and then convert a recognition result into speech and output such speech, thereby providing target guidance and walking navigation for the visually impaired people.

However, the image recognition technologies in the prior art still have problems such as low recognition accuracy and slow recognition speed in complex scenarios.

### SUMMARY

The embodiments of the present disclosure provide an image recognition method and apparatus, an electronic device, and a storage medium to overcome the problems of low recognition accuracy and slow recognition speed when performing image recognition in a complex scenario.

In a first aspect, an embodiment of the present disclosure provides an image recognition method, including:
obtaining a first instruction which is configured to indicate a target feature of an item;
obtaining an environment image, and detecting the environment image based on the first instruction to obtain a first recognition object and a second recognition object, wherein the first recognition object is an image element characterizing the target feature, and the second recognition object is a text element characterizing the target feature; and
recognizing a target item with the target feature according to the first recognition object and the second recognition object.

In a second aspect, an embodiment of the present disclosure provides an image recognition apparatus, including:
a transceiver module configured to obtain a first instruction which is configured to indicate a target feature of an item;
a processing module configured to obtain an environment image, and detect the environment image based on the first instruction to obtain a first recognition object and a second recognition object, wherein the first recognition object is an image element characterizing the target feature, and the second recognition object is a text element characterizing the target feature; and
a recognition module configured to recognize a target object with the target feature according to the first recognition object and the second recognition object.

In a third aspect, an embodiment of the present disclosure provides an electronic device, including:
a processor and a memory communicatively connected with the processor;
the memory stores a computed-executed instruction;
the processor executes the computer-executed instruction stored in the memory to realize the image recognition method described in the first aspect and various possible designs of the first aspect.

In a fourth aspect, an embodiment of the present disclosure provides a computer-readable storage medium in which computer-executable instructions are stored, and when the computer-executable instructions are executed by a processor, the image recognition method described in the first aspect and various possible designs of the first aspect are realized.

In a fifth aspect, an embodiment of the present disclosure provides a computer program product, including a computer program, when executed by a processor, realizes the image recognition method as described in the first aspect and various possible designs of the first aspect.

### BRIEF DESCRIPTION OF DRAWINGS

In order to illustrate the technical scheme of the embodiments of the present disclosure more clearly, the drawings needed in the description of the embodiments will be briefly introduced below. Obviously, the drawings in the following description are some embodiments of the present disclosure. For ordinary people in the field, other drawings can be obtained according to these drawings without creative labor.

FIG. 1 is a schematic diagram of an application scenario for an image recognition method provided in an embodiment of the present disclosure;

FIG. 2 is a flow chart 1 of an image recognition method provided in an embodiment of the present disclosure;

FIG. 3 is a flow chart of a possible implementation process of step S103 in the embodiment shown in FIG. 2;

FIG. 4 is a schematic diagram of a process for detecting an environment image based on an instruction keyword provided in an embodiment of the present disclosure;

FIG. 5 is a flow chart of another possible implementation process of step S103 in the embodiment shown in FIG. 2;

FIG. 6 is a schematic diagram of a process for recognizing a second recognition object provided in an embodiment of the present disclosure;

FIG. 7 is a flow chart of specific implementation steps of step S104 in the embodiment shown in FIG. 2;

FIG. 8 is a flow chart 2 of an image recognition method provided in an embodiment of the present disclosure;

FIG. 9 is a flow chart of specific implementation steps of step S209 in the embodiment shown in FIG. 8;

FIG. 10 is a schematic diagram of a process for determining a target item provided in an embodiment of the present disclosure;

FIG. 11 is a structural block diagram of an image recognition apparatus provided in an embodiment of the present disclosure;

FIG. 12 is a structural schematic diagram of an electronic device provided in an embodiment of this disclosure; and

FIG. 13 is a hardware structural schematic diagram of an electronic device provided in an embodiment of the present disclosure.

### DETAILED DESCRIPTION

In order to make the purpose, technical scheme and advantages of the embodiment of the disclosure clearer, the technical scheme in the embodiment of the disclosure will be described clearly and completely with the accompanying drawings. Obviously, the described embodiments are partial of the embodiments of the disclosure, but not all of the embodiments. Based on the embodiments in this disclosure, all other embodiments obtained by ordinary technicians in this field without creative labor belong to the protection scope of this disclosure.

It should be noted that the user information (including but not limited to user device information, user personal information, and the like) and data (including but not limited to data used for analysis, stored data, displayed data, and the like) involved in the present application are all information and data authorized by users or fully authorized by all parties, and the collection, use and processing of relevant data need to comply with relevant laws, regulations and standards, and corresponding operation portals need to be provided for users to choose to grant authorization or refuse the authorization.

The following explains an application scenario of an embodiment of the present disclosure.

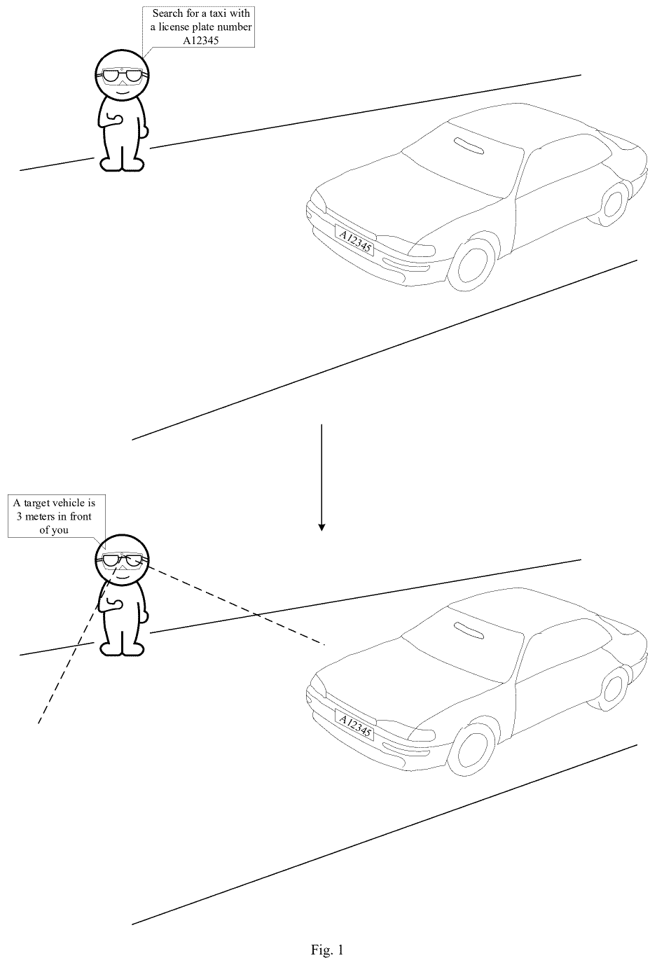

The embodiments of the present disclosure provide an image recognition method that may be applied to scenarios such as image information retrieval, target tracking, and automatic navigation, and more specifically, scenarios of interactive navigation for visually impaired people. The method provided in the embodiment of the present disclosure may be applied to a terminal device, for example, a wearable device such as smart glasses and a smart earpiece, or another electronic device with a specific computing capability. The terminal device is provided with an image acquisition unit, such as a high-definition camera, and after a user wears such a terminal device, the terminal device collects an environment image in the surrounding environment in real time through the image acquisition unit. When the terminal device receives a speech command from the user, the terminal device may recognize a target in the environment image based on the user instruction, and outputs a position of a target item to the user in the form of speech in response to recognizing the target item in the environment image, thereby providing transportation guidance and walking navigation for a visually impaired user. More specifically, FIG. 1 is a schematic diagram of an application scenario of an image recognition method provided in an embodiment of the present disclosure. For example, as shown in FIG. 1, after receiving a voice command “Search for a taxi with a license plate number A12345” from a user, a terminal device (shown as smart glasses in FIG. 1) worn by the user performs image recognition on vehicles driving on the road through a high-definition camera, and in response to detecting the taxi with the license plate number A12345, sending a voice prompt “A target vehicle is 3 meters in front of you” to the user. In this way, the visually impaired user may be automatically guided in the scenario of taking taxis.

The image recognition technology is implemented, for example, through a pre-trained image recognition model to extract an image feature from the image and categorize such image feature, thereby recognizing the target item with a specific image feature. For example, it detects and matches in the image a “person” image feature, a “vehicle” image feature, and a “zebra crossing” image feature, and in response to detecting the “person” image feature in the image, determines an image element corresponding to the image feature as a “person”, thereby providing detection of a “person” in the image. However, the scheme of recognizing a target based on an image feature is limited by the volume and training cost of the image recognition model. For example, it may only recognize a general object category, instead of a more accurate target recognition. For example, a “person” and a “bus” in the image may be recognized by using a pre-trained image recognition module. However, the “Bus No. 1” and “Bus No. 2” that have similar appearance may not be recognized. Due to this reason, problems may occur in a more complex application scenario such as transportation guidance for a visually impaired person, such as low recognition accuracy as well as slow recognition speed and increased time consumption caused by repeated execution of recognition algorithms due to absence of target items with high recognition scores.

The embodiments of the present disclosure provide an image recognition method to solve the foregoing problems.

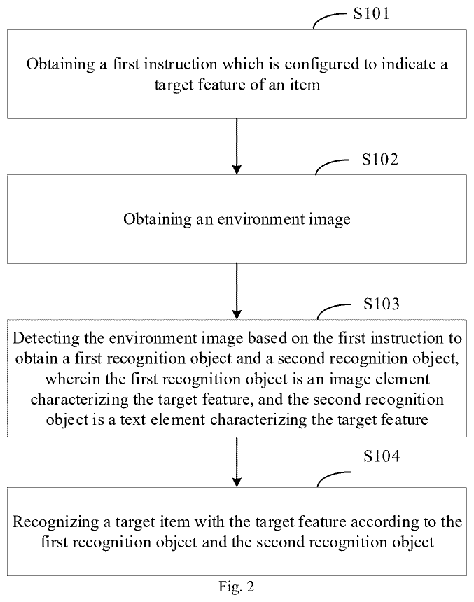

Referring to FIG. 2, FIG. 2 is a flow chart 1 of an image recognition method provided in an embodiment of the present disclosure. The method in the present embodiment may be embodied in a terminal device, and the image recognition method includes:

Step S101: obtaining a first instruction which is configured to indicate a target feature of an item.

Illustratively, a subject for implementing the present embodiment is, for example, a terminal device, and more specifically, a wearable device such as smart glasses and a smart earpiece. First instructions are obtained in corresponding ways based on different user interaction interfaces of the terminal device. In a possible implementation, the terminal device is provided with a microphone unit for receiving a sound signal, which sends out a voice that characterizes a feature of a target item when the user needs to detect the item in the current environment, and the terminal device obtains a first instruction after converting voice information through the voice signal that the microphone unit receives. In another possible implementation, the terminal device is provided with a user operation panel, where the user inputs operation information to the terminal device through an operation such as tapping on the operation panel, and the terminal device generates a corresponding first instruction after converting the operation information.

Furthermore, the first instruction is configured to indicate information of the target feature of the item. For example, the content characterized in the first instruction is “Detect Bus No. 1” and “Detect a taxi with the license plate number A 12345”. The “Bus No. 1” and the “Taxi with the license plate number A12345” are both expressions of the target feature, and based on the above target feature, one or a class of items with the above target feature may be determined, namely, the target item.

Step S102: obtaining an environment image.

Illustratively, the terminal device is configured with an image acquisition unit, such as a high-definition camera, through which image acquisition is performed to obtain an image of a surrounding environment of the current position, namely, an environment image. The image acquisition unit of the terminal device has a certain image acquisition range, that is, a certain field of view. Therefore, the environmental image may be a single-frame image obtained by the terminal device through the image acquisition unit for a single shooting, or may be a multi-frame fusion image with a larger field of view that is generated by fusion of multiple single-frame images taken at different shooting angles by the terminal device in multiple shootings through the image acquisition unit, which may be configured as need and will not be described again here.

In another possible implementation, the terminal device may receive image data sent by another electronic device such as a server, which includes the environment image. For example, after selecting and processing the image data, the terminal device obtains the environment image from the image data, which may be configured as needed and will not be described again here.

Step S103: detecting the environment image based on the first instruction to obtain a first recognition object and a second recognition object, wherein the first recognition object is an image element characterizing the target feature, and the second recognition object is a text element characterizing the target feature.

Illustratively, after obtaining the environment image, the terminal device detects the environment image in two different dimensions based on the target feature described in the first instruction, and obtains the first recognition object and the second recognition object respectively. Specifically, on the one hand, the terminal device detects the environmental image in a dimension of the image feature through an image feature recognition technology, and in response to an image feature corresponding to the target feature described by the first instruction in the captured environmental image, detects the corresponding image element from the environmental image, that is, the first recognition object. On the other hand, the terminal device detects the environmental image from a dimension of the text feature through the optical character recognition (OCR) technology, and in response to a text feature corresponding to the target feature described in the first instruction in the captured environmental image, detects the corresponding text element from the environmental image.

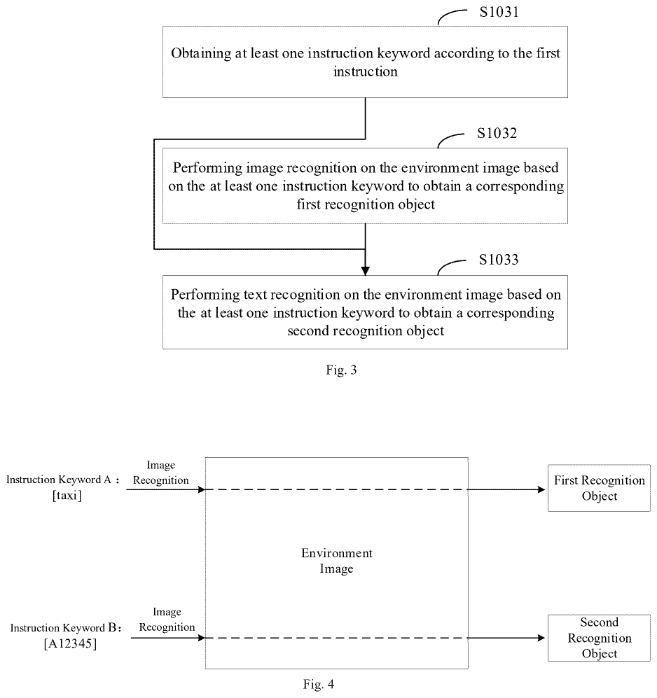

Illustratively, as shown in FIG. 3, a possible implementation process of the step S103 includes:

Step S1031: obtaining at least one instruction keyword according to the first instruction.

Step S1032: performing image recognition on the environment image based on the at least one instruction keyword to obtain a corresponding first recognition object.

Step S1033: performing text recognition on the environment image based on the at least one instruction keyword to obtain the corresponding second recognition object.

Illustratively, the instruction keyword is a word or a phrase that may be used to characterize some or all of meaning of the target feature corresponding to the first instruction. Specifically, for example, it may be a Chinese character, a phrase, a number, an English word, and a combination thereof. The instruction keyword may have complete semantics, that is, the instruction keyword is categorized by semantics. Specifically, for example, in response to that first instruction characterizes the message “Detect a taxi with a license plate number A12345”, the corresponding instruction keyword obtained based on the semantics of the first instruction includes, for example, the “license plate number A12345” and the “taxi”.

After that, in a possible implementation, the above Step S1032 and Step S1033 are executed independently to perform image recognition and text recognition on the environment image based on the instruction keyword, respectively, so as to obtain the first recognition object characterizing an image element and the second recognition object characterizing a text element. FIG. 4 is a schematic diagram of a process for detecting an environment image based on an instruction keyword provided in an embodiment of the present disclosure. As shown in FIG. 4, the environment image shows a scenario of a car driving on the road. Firstly, the terminal device analyzes based on the first instruction, and in response to obtaining the instruction keyword “license plate A12345” and “taxi” corresponding to the first instruction, on the one hand, performs image recognition on the environment image according to the instruction keyword A “taxi”. Specifically, for example, the terminal device performs feature extraction, classification and prediction on the environment image based on a preset image recognition model, and then compares the prediction result with the “taxi”, so as to recognize a vehicle in the environmental image and determine it as the first recognition object. On the other hand, according to the instruction keyword B “license plate number A12345”, it performs text recognition on the environmental image. Specifically, for example, the terminal device recognizes all characters in the environmental image based on an OCR model, and then compares the recognized characters with the “license plate number A12345”, so as to recognize a vehicle with the license plate number “A12345” in the environmental image, and determine it as the second recognition object.

Of course, it may be understood that, in the foregoing process, when the environment image does not contain the target feature, it is possible that the first recognition object and/or the second recognition object cannot be obtained, and when this occurs, the process may return to the Step S102 to collect the environment image again, so as to detect the target item in the environment continuously. Alternatively, the first recognition object and/or the second recognition object are set to a specific value (for example, 0) or null, and in response to obtaining an abnormal target item (that is, the target object is not successfully determined) in the subsequent steps, the process returns to the Step S102 to collect the environment image again, so as to detect the target item in the environment continuously.

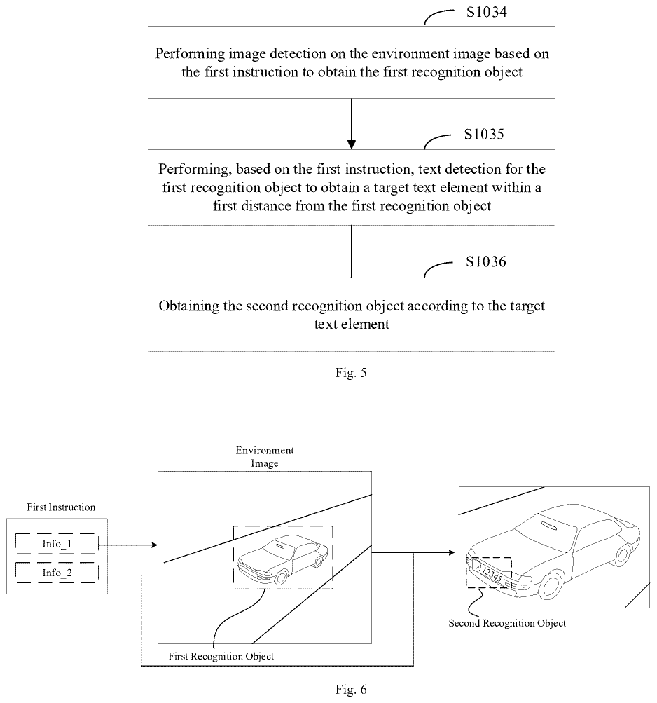

In another possible implementation, the first recognition object and the second recognition object are obtained in a specific order, and the first recognition object is configured as an input to obtain the second recognition object. Illustratively, as shown in FIG. 5, another possible implementation process of the Step S103 includes:

Step S1034: performing image detection on the environment image based on the first instruction to obtain the first recognition object.

Step S1035: performing, based on the first instruction, text detection for the first recognition object to obtain a target text element within a first distance from the first recognition object.

Step S1036: obtaining the second recognition object according to the target text element.

Illustratively, after performing image detection on the environment image based on the image feature characterized by the first instruction, one or more recognition objects, for example, a plurality of vehicles driving on the road are obtained. Then, text detection is performed, based on the text feature characterized by the first instruction, for the first recognition object, to obtain a target text located in or near the first recognition object, for example the license plate number located in the vehicle outline, which is determined as the second recognition object. FIG. 6 is a schematic diagram of a process for recognizing a second recognition object provided in an embodiment of the present disclosure. As shown in FIG. 6, firstly, all the first recognition object “vehicle” in the environmental image are recognized based on the information “Info_1” which characterizes the image feature in the first instruction. Then, based on the information “Info_2” which characterizes the text feature in the first instruction, OCR text recognition is performed from a recognized block corresponding to the “vehicle” in the environmental image to obtain the target text element “AB12345” matching the information “Info_2”, which is determined as the second recognition element.

In this embodiment, by first determining the first recognition object, and then with the first recognition object as an input, detecting the target text element within the first distance from the first recognition object in the environment image, the range required for the text recognition in the environment image is reduced, which increases the speed and accuracy of obtaining the target text element, thereby providing fast and accurate recognition of the second recognition object.

Step S104: recognizing a target item with the target feature according to the first recognition object and the second recognition object.

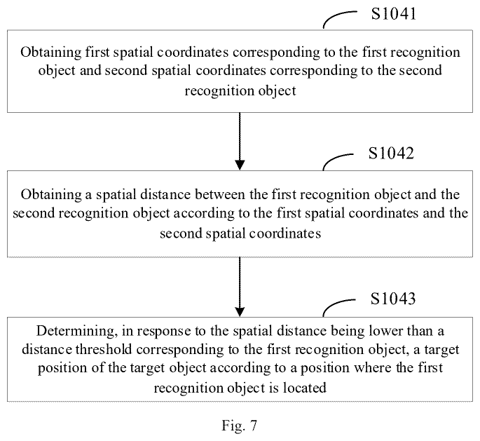

Illustratively, after obtaining the first recognition object and the second recognition object through the above steps, whether the first recognition object is the target item is determined according to a position relationship between the first recognition object and the second recognition object, thereby recognizing the target item. Specifically, as shown in FIG. 7, a specific implementation process of the Step S204 may include:

Step S1041: obtaining first spatial coordinates corresponding to the first recognition object and second spatial coordinates corresponding to the second recognition object.

Step S1042: obtaining a spatial distance between the first recognition object and the second recognition object according to the first spatial coordinates and the second spatial coordinates.

Step S1043: determining, in response to that the spatial distance is lower than a distance threshold corresponding to the first recognition object, a target position of the target item according to a position where the first recognition object is located.

Specifically, since the first recognition object is an image element that characterizes the target feature, and the second recognition object is a text element that characterizes the target feature, one or more image elements that are similar as the target item in the dimension of the image feature, such as a plurality of vehicles with a similar appearance, may be determined according to the first recognition object. In addition, the text element that characterizes the target feature, such as the “license plate number” in the above embodiment, may be determined according to the second recognition object. Then, based on the distance relationship between the first recognition object and the second recognition object, an attribution relationship between the first recognition object and the second recognition object is determined, that is, the “vehicle” to which the “license plate number” belongs. Specifically, when the distance between the first recognition object and the second recognition object is greater than a distance threshold, the text element corresponding to the second recognition object may not be attributed to the image element corresponding to the first recognition object, that is, the “license plate number” and the “vehicle” do not correspond to a same target item. Conversely, when the distance between the first recognition object and the second recognition object is lower than the distance threshold, the text element corresponding to the second recognition object may be attributed to the image element corresponding to the first recognition object, that is, the “license plate number” and “vehicle” correspond to the same target item. The distance threshold may be a fixed value or a dynamic value determined based on a feature of the first recognition object, such as a spatial position, an object category, a dimensional size, and the like of the first recognition object.

Furthermore, according to the first recognition object and the second recognition object, in response to that the position relationship between the first recognition object and the second recognition object satisfies a preset requirement, for example, a spatial distance between the first recognition object and the second recognition object is lower than a distance threshold, the first recognition object and the second recognition object are determined to correspond to the same target item, and therefore the first recognition object that characterizes the image element of the target item is the target item. The location where the first recognition object is located is the target position of the target item.

In a possible case, for example, there are multiple sets of first recognition objects and second recognition objects in the environment image. In the process of determining the first recognition object as the target item by using the second recognition object (text feature) as the reference information of the first recognition object (image feature), the first recognition object and the second recognition object need to be matched first. In this embodiment, the first recognition object is matched to the second recognition object through the position relationship of the first recognition object and the second recognition object, thereby determining the target item by using the second recognition object as the reference information of the first recognition object, and improving efficiency and accuracy in recognizing the target item.

In another possible implementation, the first recognition object and the second recognition object may be converted into corresponding semantics and matched, so as to achieve the above purpose, which will not be described again here.

This embodiment is implemented by obtaining a first instruction, where the first instruction is configured to indicate the target feature of the object; obtaining the environment image; detecting the environment image based on the first instruction to obtain a first recognition object and a second recognition object, where the first recognition object is an image element characterizing the target feature, and the second recognition object is a text element characterizing the target feature; and recognizing a target item with the target feature based on the first recognition object and the second recognition object. The environment image is detected through the first instruction entered by the user that is configured to indicate the target feature to obtain the first recognition object that characterizes the image element and the second recognition object that characterizes the text element respectively, and then the first recognition object and the second recognition object are used to recognize a target from the two dimensions of the image element and the text element, where the text element is used as the reference information of the image element to carry out more accurate target recognition, thereby accurately recognizing the target item in the environment image, which improves the recognition accuracy, and solves the problems of low recognition accuracy and slow recognition speed.

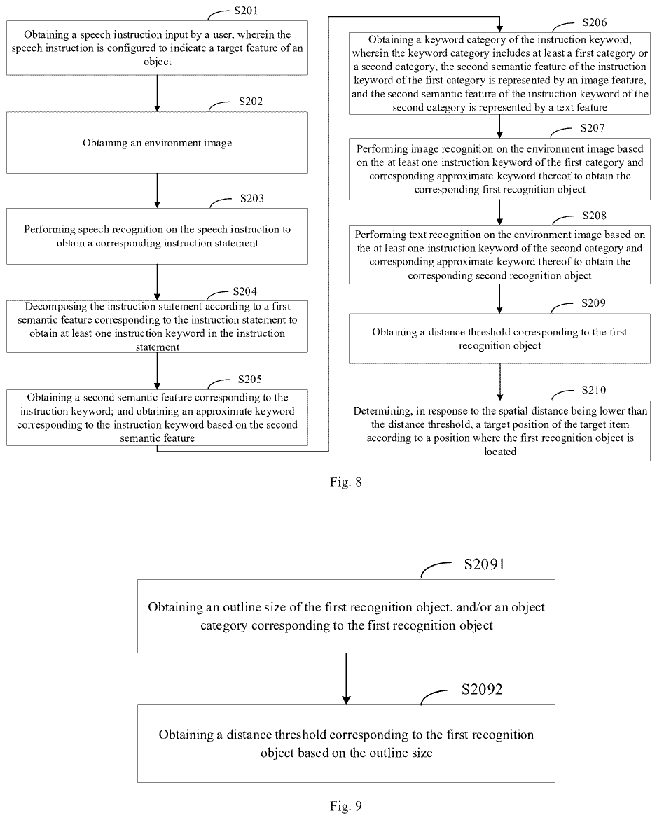

Referring to FIG. 8, FIG. 8 is a flow chart 2 of an image recognition method provided in an embodiment of the present disclosure. Based on the embodiment shown in FIG. 2, the present embodiment further refines the steps S102 and S104 with an additional step for user interaction, and the image recognition method includes:

Step S201: obtaining a speech instruction input by a user, wherein the speech instruction is configured to indicate a target feature of an item.

Step S202: obtaining an environment image.

Illustratively, Step S201 is a specific implementation for obtaining the first instruction by the terminal device, where a speech instruction input by a user is obtained through a microphone unit configured to receive a sound signal. The specific implementations of Step S201 and Step S202 are described in detail in the embodiment shown in FIG. 2 and will not be described again here.

Step S203: performing speech recognition on the speech instruction to obtain a corresponding instruction statement.

Step S204: decomposing the instruction statement according to a first semantic feature corresponding to the instruction statement to obtain at least one instruction keyword in the instruction statement.

Illustratively, after obtaining the speech instruction, where the speech instruction may be an audio signal, speech recognition may be performed on the speech instruction to obtain the text content that the speech instruction expresses, that is, the instruction statement. Natural language recognition may be performed on the audio signal to obtain the specific implementation of the corresponding natural statement, which will not be described again here.

Furthermore, Illustratively, after obtaining the instruction statement, the instruction statement is decomposed into words or phrases that make up the instruction statement, and the meaningless words or phrases are filtered out to obtain one or more keywords that can characterize the target feature, that is, the instruction keyword. The specific meaning of the instruction keyword has been described in the embodiment shown in FIG. 2 and will not be described again here. For example, if the instruction statement obtained through speech recognition is “Help me find a taxi with a license plate number A12345”, the instruction keywords obtained by decomposing the instruction statement include “taxi” and “A12345”.

Illustratively, considering the subjectivity and arbitrariness of the speech instruction issued by the user, when the speech instruction generates a complex instruction statement, different rules need to be followed for the splitting and filtering of the instruction statement. In this embodiment, the instruction statement is analyzed based on the first semantic feature corresponding to the instruction statement, where the first semantic feature corresponding to the instruction statement is information configured to describe the content and context of the instruction statement. For example, the instruction statement is “Find Bus No. 1 to place A”, and the corresponding instruction keywords obtained according to the content and context (that is, the first semantic feature) expressed by the instruction statement include “to”, “place A”, “No. 1”, and “Bus”, while when the instruction statement is “go to Bus No. 1”, the instruction keywords obtained according to the content and context expressed by the instruction statement include “No. 1” and “Bus”. According to the first semantic feature, it may be determined that the word “to” does not represent an actual meaning, that is, it does not characterize the target feature, and therefore, the obtained instruction keyword does not contain “to”.

In the present embodiment, the first semantic feature corresponding to the instruction statement that corresponds to the speech instruction is obtained to accurately analyze the instruction statement, thereby improving the accuracy of the instruction keyword, and improving accuracy in searching and positioning the target item.

Optionally, after Step S204, the method further includes:

Step S205: obtaining a second semantic feature corresponding to the instruction keyword; and obtaining an approximate keyword corresponding to the instruction keyword based on the second semantic feature.

Illustratively, after obtaining the instruction keyword, in order to reduce the influence of the arbitrariness of the speech instruction issued by the user on the search process, a synonym with a similar meaning, that is, an approximate keyword, may be generated according to a second semantic feature of the instruction keyword, where the second semantic feature is the information that characterizes the meaning and content of the instruction keyword. For example, if the instruction keyword is “Bus”, a corresponding approximate keyword such as “coach” and “autobus” may be obtained from a preset thesaurus according to the second semantic feature of the instruction keyword, and then the instruction keyword and the corresponding approximate keyword thereof are used together to search for the text element in the environment image, thereby improving the efficiency and range in matching the target text element and improving the accuracy in recognizing the target item.

Step S206: obtaining a keyword category of the instruction keyword, wherein the keyword category includes at least a first category or a second category, the second semantic feature of the instruction keyword of the first category is represented by an image feature, and the second semantic feature of the instruction keyword of the second category is represented by a text feature.

Illustratively, the instruction keyword belongs to a corresponding keyword category, where the keyword category includes at least the first category or the second category, that is, the instruction keyword may be the instruction keyword of the first category, or the instruction keyword may be the instruction keyword of the second category. Specifically, the second semantic feature of the instruction keyword of the first category is represented by an image feature, that is, the content of the instruction keywords of the first category may be represented by the image feature, and more specifically, for example, the instruction keyword of the first category may be “car”, “pedestrian”, “shelf”, “door”, and so on. The second semantic feature of the second category of instruction keyword is represented by a text feature, that is, the content of the second category of instruction keyword may be expressed through the text feature, and more specifically, for example, the instruction keyword of the second category may be “No. 2”, “A12345”, “men's toilet”, and the like. The content of the instruction keyword is mapped to the keyword category through a predefined mapping relationship. Illustratively, the keyword category corresponding to the instruction keyword may be obtained by recognizing the instruction keyword through a pre-trained recognition model.

In a possible implementation, the keyword category also includes a third category. In other words, the instruction keyword may be the first category, or the second category, or the third category. The second semantic feature of the instruction keyword of the first category is represented only by an image feature, the second semantic feature of the instruction keyword of the second category is represented by a text feature; and the second semantic feature of the instruction keyword of the third category is represented by both the image feature and the text feature.

Step S207: performing image recognition on the environment image based on the at least one instruction keyword of the first category and corresponding approximate keyword thereof to obtain the corresponding first recognition object.

Step S208: performing text recognition on the environment image based on the at least one instruction keyword of the second category and corresponding approximate keyword thereof to obtain the corresponding second recognition object.

Illustratively, after obtaining the keyword category corresponding to the instruction keyword, the corresponding steps are executed according to the keyword category corresponding to the instruction keyword to obtain the corresponding first recognition object and the second recognition object. Specifically, for example, on the one hand, the image elements in the environment image are segmented and the corresponding image features are extracted, and then the corresponding image feature corresponding to each image element is mapped to a description text, such as “car” and “bus”, and then the description text is compared to the instruction keyword of the first category or of the third category, and in response to that the description text is consistent with the instruction keyword, the image element is determined as the first object. On the other hand, an OCR technology is used to recognize and extract the text features in the environment image to obtain text elements, such as “No. 2”, “men's toilet”, and “A12345”, and the text elements are compared to the instruction keyword of the second or of the third category, and in response to that the text element is consistent with the instruction keyword, the text element is determined as the second object.

In the present embodiment, the instruction keywords are categorized to distinguish the instruction keyword of the first type and the second type, and the corresponding first recognition object and the second recognition object are respectively determined based on the instruction types, thereby accurately detecting the image element and the text element with target feature in the environmental image, and improving the accuracy in subsequently determining the target item.

Step S209: obtaining a distance threshold corresponding to the first recognition object.

Illustratively, in a possible implementation, the distance threshold for the first recognition object may be a fixed value determined based on an image scene of the environment image. For example, in response to that the image scene described by the environment image is an indoor scene, the distance threshold corresponding to the first recognition object is 0.2 meters, and in response to that the image scene described by the environment image is an outdoor scene, the distance threshold corresponding to the first recognition object is 1 meter.

In another possible embodiment, the distance threshold for the first recognition object is associated with an outline size of the first recognition object, and a distance threshold that matches the outline size of the first recognition object is determined, and then whether a surrounding text element belongs to the first recognition object is determined based on the distance threshold.

Illustratively, as shown in FIG. 9, a specific implementation process of the Step S209 includes:

Step S2091: obtaining an outline size of the first recognition object, and/or an object category corresponding to the first recognition object.

Step S2092: obtaining a distance threshold corresponding to the first recognition object based on the outline size.

In a possible embodiment, Illustratively, after the first recognition object (image element) in the environment image is recognized, the outline size of the first recognition object, such as a diagonal length of a rectangular box surrounding the image element, may be obtained from a reference object or a camera parameter in the environment image, which will not be described again here. Then, according to the outline size, based on a preset mapping relationship, the corresponding distance threshold is determined, and the outline size is proportional to the distance threshold. In another possible implementation, the object category corresponding to the first recognition object such as “bus” may be recognized, and the corresponding distance threshold may also be determined based on the object category independently or in combination with an outline size. Illustratively, in response to that the first recognition object is a “bus”, which has a large outline size, the corresponding distance threshold thereof is also large, and in response to that the first recognition object is a “toilet door”, which has a small outline size, the corresponding distance threshold is also small. In the present embodiment, the corresponding distance threshold is determined through the outline size and/or object category of the first recognition object, such that the first recognition object and the second recognition object are matched in a higher probability of correctness, thereby improving the accuracy in recognizing the target item.

Step S210 determining, in response to that the spatial distance is lower than the distance threshold, a target position of the target item according to a position where the first recognition object is located.

Illustratively, the spatial distance between the first recognition object and the second recognition object is compared based on the distance threshold. In response to that the spatial distance between the first recognition object and the second recognition object is lower than the distance threshold, the first recognition object is determined as the target item, and then the target position is determined based on the position of the first recognition object. After that, the terminal device delivers a voice broadcast based on the target position to prompt the user. On the other hand, in response to that the spatial distance between the first recognition object and the second recognition object is greater than the distance threshold, then the first recognition object is determined as not the target item, then the process returns to Step S202 to acquire the environment image again to detect the environment where the terminal device is located continuously.

The spatial distance between the first recognition object and the second recognition object may be determined by the spatial distance from the outline center point of the first recognition object to the outline center point of the second recognition object. Furthermore, because the environment image is a two-dimensional image, the spatial distance between the objects of the two-dimensional image is calculated, which requires mapping to the three-dimensional space. Therefore, the terminal device needs to obtain a three-dimensional space model of the real environment characterized by the environmental image, and the three-dimensional space model may be pre-generated or generated based on the environment image, which will not be described again here in detail.

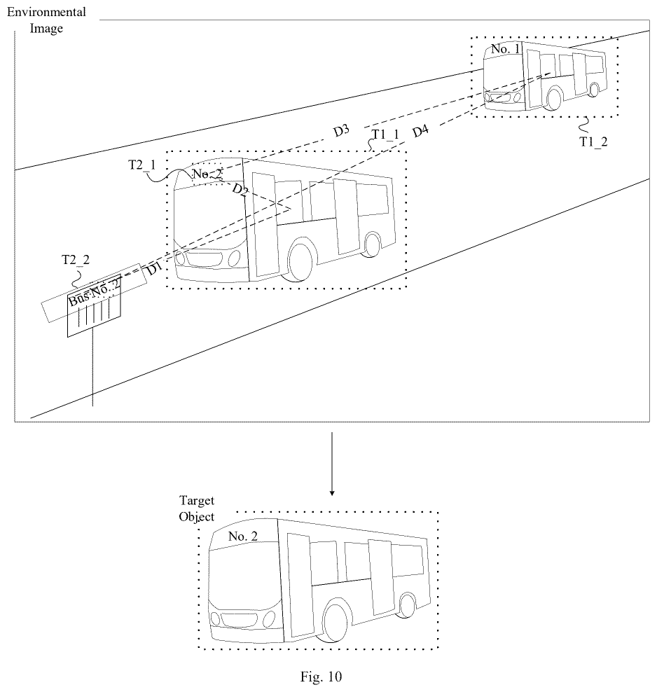

FIG. 10 is a schematic diagram of a process for determining a target item provided in an embodiment of the present disclosure. As shown in FIG. 10, through recognizing the environmental image, two first recognition objects and two second recognition objects in the environmental image are obtained, where as shown in the figure, the two first recognition objects are T1_1 and T1_2 respectively, and the first recognition object T1_1 and the T1_2 correspond to the image element “bus”; the two second recognition objects are T2_1 and T2_2, respectively, and the two second recognition objects T2_1 and T2_2 correspond to the text element “No. 2”. The two first recognition objects and the two second recognition objects are recognition results obtained in the environment image based on the first instruction. After that, the spatial distances DI to D4 between the first recognition objects and the second recognition objects are obtained, and the spatial distances are compared sequentially based on a distance threshold, where D2 is lower than the distance threshold, indicating that the first recognition object and the second recognition object to which D2 corresponds belong to a same object, that is, the text element “No. 2” characterized by the second recognition object describes the image element “bus” of the first recognition object. Therefore, the first recognition object corresponding to the spatial distance D2 that is lower than the distance threshold is determined as the target item.

In the steps of the present embodiment, the matched first recognition object and the second recognition object are determined by comparing the spatial distances of the first recognition objects and the second recognition objects to the distance threshold, thereby recognizing the target item accurately, improving the accuracy in recognizing the target item, and finally providing functions such as information search, target guidance, and appearance navigation for the visually impaired people.

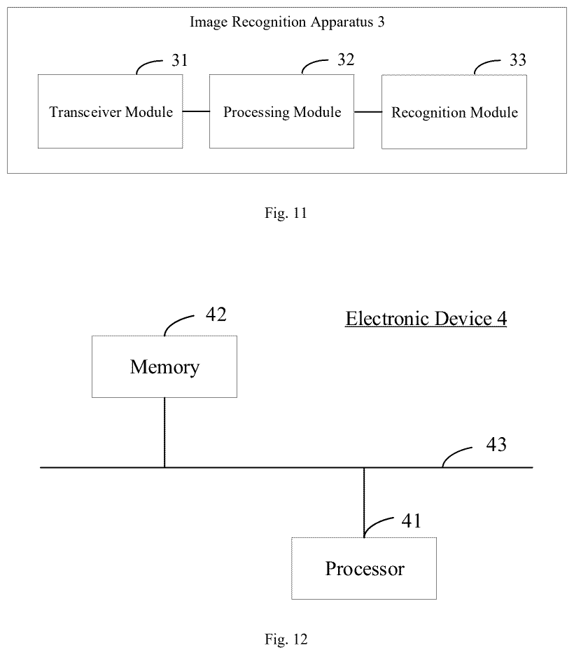

Corresponding to the image recognition method of the embodiments above, FIG. 11 is a block diagram of the image recognition apparatus provided in an embodiment of the present disclosure. For illustrative purposes, only those parts relevant to the embodiments of the present disclosure are shown. Referring to FIG. 11, the image recognition apparatus 3 includes:
a transceiver module 31 configured to obtain a first instruction that is configured to indicate a target feature of an item;
a processing module 32 configured to obtain an environment image, and detect the environment image based on the first instruction to obtain a first recognition object and a second recognition object, wherein the first recognition object is an image element characterizing the target feature, and the second recognition object is a text element characterizing the target feature; and
a recognition module 33 configured to recognize a target item with the target feature according to the first recognition object and the second recognition object.

In an embodiment of the present disclosure, when detecting the environmental image based on the first instruction to obtain the first recognition object and the second recognition object, the processing module 32 is specifically configured to: obtain at least one instruction keyword according to the first instruction; perform image recognition on the environment image based on the at least one instruction keyword to obtain the corresponding first recognition object; and perform text recognition on the environment image based on the at least one instruction keyword to obtain the corresponding second recognition object.

In an embodiment of the present disclosure, the first instruction is a speech instruction, and when obtaining the at least one instruction keyword according to the first instruction, the processing module 32 is specifically configured to: perform speech recognition on the speech instruction to obtain a corresponding instruction statement; and decompose the instruction statement according to a first semantic feature corresponding to the instruction statement to obtain at least one instruction keyword in the instruction statement.

In one embodiment of the present disclosure, after decomposing the instruction statement based on scene information to obtain the at least one instruction keyword in the instruction statement, the processing module 32 is further configured to: obtain a second semantic feature corresponding to the instruction keyword; and obtain an approximate keyword corresponding to the instruction keyword based on the second semantic feature, wherein the approximate keyword is configured to perform the text recognition and/or the image recognition on the environment image to obtain the first recognition object and/or the second recognition object.

In an embodiment of the present disclosure, the processing module 32 is further configured to: obtain a keyword category of the instruction keyword, the keyword category includes at least a first category or a second category, a second semantic feature of the instruction keyword of the first category is represented by an image feature, and the second semantic feature of the instruction keyword of the second category is represented by a text feature. When performing image recognition on the environment image based on the at least one instruction keyword to obtain a corresponding first recognition object, the processing module 32 is specifically configured to: perform the image recognition on the environment image based on at least one instruction keyword of the first category to obtain the corresponding first recognition object. When the performing text recognition on the environment image based on the at least one instruction keyword to obtain a corresponding second recognition object, the processing module 32 is specifically configured to: perform the text recognition on the environment image based on at least one instruction keyword of the second category to obtain the corresponding second recognition object.

In an embodiment of the present disclosure, the processing module 32 is specifically configured to: perform image detection on the environment image based on the first instruction to obtain the first recognition object; perform, based on the first instruction, text detection on the first recognition object to obtain a target text element within a first distance from the first recognition object; and obtain the second recognition object based on the target text element.

In an embodiment of the present disclosure, the recognition module 33 is specifically configured to: obtain first spatial coordinates corresponding to the first recognition object and second spatial coordinates corresponding to the second recognition object; obtain a spatial distance between the first recognition object and the second recognition object based on the first spatial coordinates and the second spatial coordinates; obtain a distance threshold corresponding to the first recognized object; and determine, in response to that the spatial distance is lower than the distance threshold, a target position of the target item based on the position of the first recognized object.

In an embodiment of the present disclosure, when obtaining a distance threshold corresponding to the first recognition object, the recognition module 33 is specifically configured to: obtain an outline size of the first recognition object; obtain, based on the outline size, the object category corresponding to the first recognition object; and determine the distance threshold corresponding to the first recognition object based on the outline size and/or object category.

The transceiver module 31, the processing module 32 and the recognition module 33 are connected sequentially. The image recognition apparatus 3 provided in the present embodiment may be used to implement the technical solution of the above method embodiments, with the same implementation principle and technical effect, which are not described again in the present embodiment.

FIG. 12 is a structural schematic diagram of an electronic device provided in an embodiment of the present disclosure. As shown in FIG. 12, the electronic device 4 includes:
a processor 41, and a memory 42 communicatively connected with the processor 41;
the memory 42 stores a computed-executed instruction; and
the processor 41 executes the computed-executed instruction stored in the memory 42 to implement the image recognition method shown in FIG. 2 to FIG. 10.

Optionally, the processor 41 and the storage 42 are connected through a bus 43.

The relevant description may be understood in accordance with the relevant description and effect corresponding to the steps in the corresponding embodiments in FIG. 2 to FIG. 10, which are not described again here.

The embodiments of the disclosure provide a computer-readable storage medium with a computer-executed instruction stored thereon, when the computer-executed instruction is executed by a processor, the processor is configured to implement the image recognition method provided in any one of the embodiments corresponding to FIG. 2 to FIG. 10 of the present application.

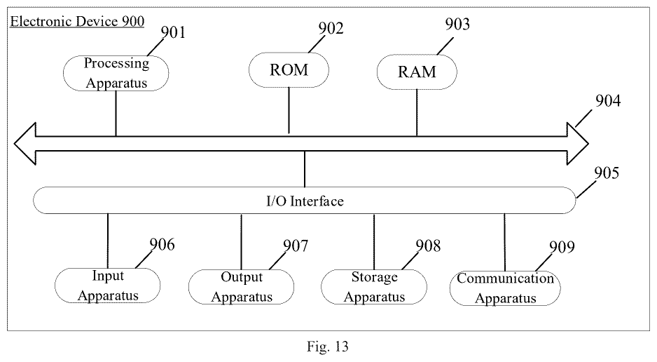

Referring to FIG. 13, FIG. 13 illustrates a schematic structural diagram of an electronic device 900 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 13 is merely an example, and should not pose any limitation to the functions and the range of use of the embodiments of the present disclosure.

As illustrated in FIG. 13, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 13 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method in the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, according to one or more embodiments of the present disclosure, an image recognition method is provided, and the method includes:
obtaining a first instruction, where the first instruction is configured to indicate a target feature of an item; obtaining an environment image, and detecting the environment image based on the first instruction to obtain a first recognition object and a second recognition object, wherein the first recognition object is an image element characterizing the target feature, and the second recognition object is a text element characterizing the target feature; and recognizing a target item with the target feature based on the first recognition object and the second recognition object.

In one or more embodiments of the present disclosure, the detecting the environmental image based on the first instruction to obtain a first recognition object and a second recognition object includes: obtaining at least one instruction keyword according to the first instruction; based on the at least one instruction keyword, performing image recognition on the environment image to obtain the corresponding first recognition object; and based on the at least one instruction keyword, performing text recognition on the environment image to obtain the corresponding second recognition object.

According to one or more embodiments of the present disclosure, the first instruction is a speech instruction, and the obtaining at least one instruction keyword according to the first instruction includes: performing speech recognition on the speech instruction to obtain a corresponding instruction statement; and based on a first semantic feature corresponding to the instruction statement, decomposing the instruction statement to obtain the at least one instruction keyword in the instruction statement.

According to one or more embodiments of the present disclosure, after decomposing the instruction statement based on scene information to obtain the at least one instruction keyword in the instruction statement, the method further includes: obtain a second semantic feature corresponding to the instruction keyword; based on the second semantic feature, obtaining an approximate keyword corresponding to the instruction keyword, where the approximate keyword is configured to perform text recognition and/or image recognition on the environment image to obtain the first recognition object and/or the second recognition object.

According to one or more embodiments of the present disclosure, the image recognition method further includes: obtaining a keyword category of the instruction keyword, where the keyword category includes at least a first category or a second category, a second semantic feature of the instruction keyword of the first category is represented through an image feature, and the second semantic feature of the instruction keyword of the second category is represented through a text feature. The performing image recognition on the environment image based on the at least one instruction keyword to obtain a corresponding first recognition object includes: performing image recognition on the environment image based on the at least one instruction keyword of the first category to obtain the corresponding first recognition object. The performing text recognition on the environment image based on the at least one instruction keyword to obtain a corresponding second recognition object includes: performing text recognition on the environment image based on the at least one instruction keyword of the second category to obtain the corresponding second recognition object.

According to one or more embodiments of the present disclosure, the detecting the environment image based on the first instruction to obtain a first recognition object and a second recognition object includes: performing image detection on the environment image based on the first instruction to obtain the first recognition object; based on the first instruction, performing text detection on the first recognition object to obtain a target text element within a first distance from the first recognition object; and based on the target text element, obtaining the second recognition object.

According to one or more embodiments of the present disclosure, the recognizing a target item with the target feature according to the first recognition object and the second recognition object includes: obtaining first spatial coordinates corresponding to the first recognition object and second spatial coordinates corresponding to the second recognition object; based on the first spatial coordinates and the second spatial coordinates, obtaining a spatial distance between the first recognition object and the second recognition object; obtaining a distance threshold corresponding to the first recognition object; and in response to that the spatial distance is lower than the distance threshold corresponding to the first recognition object, obtaining a target position of the target item based on the position of the first recognition object.

According to one or more embodiments of the present disclosure, the obtaining a distance threshold corresponding to the first recognition object includes: obtaining an outline size of the first recognition object, and/or a object category corresponding to the first recognition object; and based on the outline size and/or object category, determining the distance threshold corresponding to the first recognition object.

In a second aspect, according to one or more embodiments of the present disclosure, an image recognition apparatus is provided, and the image recognition apparatus includes:
a transceiver module configured to obtain a first instruction that is configured to indicate a target feature of an item;
a processing module configured to obtain an environment image, and detect the environment image based on the first instruction to obtain a first recognition object and a second recognition object, where the first recognition object is an image element characterizing the target feature, and the second recognition object is a text element characterizing the target feature; and
a recognition module configured to recognize a target item with the target feature according to the first recognition object and the second recognition object.

According to one or more embodiments of the present disclosure, in the detecting the environmental image based on the first instruction to obtain a first recognition object and a second recognition object, the processing module is specifically configured to: obtain at least one instruction keyword according to the first instruction; based on the at least one instruction keyword, perform image recognition on the environment image to obtain the corresponding first recognition object; and based on the at least one instruction keyword, perform text recognition on the environment image to obtain the corresponding second recognition object.

According to one or more embodiments of the present disclosure, the first instruction is a speech instruction, and in the obtaining at least one instruction keyword according to the first instruction, the processing module is specifically configured to: perform speech recognition on the speech instruction to obtain a corresponding instruction statement; and based on a first semantic feature corresponding to the instruction statement, decompose the instruction statement to obtain the at least one instruction keyword in the instruction statement.

According to one or more embodiments of the present disclosure, after decomposing the instruction statement based on scene information to obtain the at least one instruction keyword in the instruction statement, the processing module is further configured to: obtain a second semantic feature corresponding to the instruction keyword; based on the second semantic feature, obtain an approximate keyword corresponding to the instruction keyword, where the approximate keyword is configured to perform text recognition and/or image recognition on the environment image to obtain the first recognition object and/or the second recognition object.

According to one or more embodiments of the present disclosure, the processing module is further configured to: obtain a keyword category of the instruction keyword, where the keyword category includes at least a first category or a second category, a second semantic feature of the instruction keyword of the first category is represented through an image feature, and the second semantic feature of the instruction keyword of the second category is represented through a text feature. In the performing image recognition on the environment image based on the at least one instruction keyword to obtain a corresponding first recognition object, the processing module 32 is specifically configured to: perform image recognition on the environment image based on the at least one instruction keyword of the first category to obtain the corresponding first recognition object. In the performing text recognition on the environment image based on the at least one instruction keyword to obtain a corresponding second recognition object, the processing module 32 is specifically configured to: perform text recognition on the environment image based on the at least one instruction keyword of the second category to obtain the corresponding second recognition object.

According to one or more embodiments of the present disclosure, the processing module is specifically configured to: perform image detection on the environment image based on the first instruction to obtain the first recognition object; based on the first instruction, perform text detection on the first recognition object to obtain a target text element within a first distance from the first recognition object; and based on the target text element, obtain the second recognition object.

According to one or more embodiments of the present disclosure, the recognition module is specifically configured to: obtain first spatial coordinates corresponding to the first recognition object and second spatial coordinates corresponding to the second recognition object; based on the first spatial coordinates and the second spatial coordinates, obtain a spatial distance between the first recognition object and the second recognition object; and in response to that the spatial distance is lower than the distance threshold corresponding to the first recognition object, obtain a target position of the target item based on the position of the first recognition object.

According to one or more embodiments of the present disclosure, the recognition module is further configured to: obtain an outline size of the first recognition object, and/or a object category corresponding to the first recognition object; and based on the outline size and/or object category, determine the distance threshold corresponding to the first recognition object.

In a third aspect, according to one or more embodiments of the present disclosure, an electronic device is provided, and the electronic device includes: a processor and a memory communicatively connected to the processor;
where the memory stores a computed-executed instruction; and
the processor executes the computed-executed instruction stored in the memory to implement the image recognition method in the first aspect and various possible designs of the first aspect above.

In a fourth aspect, according to one or more embodiments of the present disclosure, a computer-readable storage medium with a computer-executed instruction stored thereon is provided, where the computer-executed instruction, when being executed by a processor, implements the image recognition method in the first aspect and various possible designs of the first aspect above.

In a fifth aspect, the embodiments of the present disclosure provide a computer program product including a computer program that, when being executed by a processor, implements the image recognition method in the first aspect and various possible designs of the first aspect above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An image recognition method, comprising:
obtaining a first instruction which is configured to indicate a first feature of an item;
obtaining an environment image, and detecting the environment image based on the first instruction to obtain a first recognition object and a second recognition object, wherein the first recognition object is an image element characterizing the first feature, and the second recognition object is a text element characterizing the first feature; and
recognizing first item with the first feature according to the first recognition object and the second recognition object.

2. The method according to claim 1, wherein detecting the environment image based on the first instruction to obtain the first recognition object and the second recognition object comprises:
obtaining at least one instruction keyword according to the first instruction;
performing image recognition on the environment image based on the at least one instruction keyword to obtain the corresponding first recognition object; and
performing text recognition on the environment image based on the at least one instruction keyword to obtain the corresponding second recognition object.

3. The method according to claim 2, wherein the first instruction is a speech instruction, and obtaining the at least one instruction keyword according to the first instruction comprises:
performing speech recognition on the speech instruction to obtain a corresponding instruction statement; and
decomposing the instruction statement according to a first semantic feature corresponding to the instruction statement to obtain at least one instruction keyword in the instruction statement.

4. The method according to claim 3, wherein after decomposing the instruction statement to obtain the at least one instruction keyword in the instruction statement, the method further comprises:
obtaining a second semantic feature corresponding to the instruction keyword; and
obtaining an approximate keyword corresponding to the instruction keyword based on the second semantic feature, wherein the approximate keyword is configured to perform the text recognition and/or the image recognition on the environment image to obtain the first recognition object and/or the second recognition object.

5. The method according to claim 2, further comprising:
obtaining a keyword category of the instruction keyword, wherein the keyword category comprises at least a first category or a second category, a second semantic feature of the instruction keyword of the first category is represented by an image feature, and the second semantic feature of the instruction keyword of the second category is represented by a text feature;
wherein the performing image recognition on the environment image based on the at least one instruction keyword to obtain the corresponding first recognition object comprises:
performing the image recognition on the environment image based on at least one instruction keyword of the first category to obtain the corresponding first recognition object; and
wherein the performing text recognition on the environment image based on the at least one instruction keyword to obtain the corresponding second recognition object comprises:
performing the text recognition on the environment image based on at least one instruction keyword of the second category to obtain the corresponding second recognition object.

6. The method according to claim 1, wherein detecting the environment image based on the first instruction to obtain the first recognition object and the second recognition object comprises:
performing, based on the first instruction, image detection on the environment image to obtain the first recognition object;
performing, based on the first instruction, text detection for the first recognition object to obtain a target text element within a first distance from the first recognition object; and
obtaining the second recognition object according to the target-text element.

7. The method according to claim 1, wherein recognizing the first item with the first feature according to the first recognition object and the second recognition comprises:
obtaining first spatial coordinates corresponding to the first recognition object and second spatial coordinates corresponding to the second recognition object;
obtaining a spatial distance between the first recognition object and the second recognition object according to the first spatial coordinates and the second spatial coordinates;
obtaining a distance threshold corresponding to the first recognition object; and
determining, in response to the spatial distance being lower than the distance threshold, a first position of the first item according to a position where the first recognition object is located.

8. The method according to claim 7, wherein obtaining the distance threshold corresponding to the first recognition object comprises:
obtaining an outline size of the first recognition object, and/or an object category corresponding to the first recognition object; and
determining the distance threshold corresponding to the first recognition object based on the outline size and/or the object category.

9-16. (canceled)

17. An electronic device comprising:
at least a processor, and
a non-transitory memory with instructions thereon,
wherein the instructions upon execution by the processor, cause the processor to:
obtain a first instruction which is configured to indicate a first feature of an item;
obtain an environment image, and detect the environment image based on the first instruction to obtain a first recognition object and a second recognition object, wherein the first recognition object is an image element characterizing the first feature, and the second recognition object is a text element characterizing the first feature; and
recognize a first item with the first feature according to the first recognition object and the second recognition object.

18. A non-transitory computer-readable storage medium according storing instructions that cause at least a processor to:
obtain a first instruction which is configured to indicate a first feature of an item;
obtain an environment image, and detect the environment image based on the first instruction to obtain a first recognition object and a second recognition object, wherein the first recognition object is an image element characterizing the first feature, and the second recognition object is a text element characterizing the first feature; and
recognize a first item with the first feature according to the first recognition object and the second recognition object.

19. (canceled)

20. The electronic device according to claim 17, wherein when detecting the environment image based on the first instruction to obtain the first recognition object and the second recognition object, the processor is further configured to:
obtain at least one instruction keyword according to the first instruction;
perform image recognition on the environment image based on the at least one instruction keyword to obtain the corresponding first recognition object; and
perform text recognition on the environment image based on the at least one instruction keyword to obtain the corresponding second recognition object.

21. The electronic device according to claim 20, wherein the first instruction is a speech instruction, and when obtaining the at least one instruction keyword according to the first instruction, the processor is further configured to:
perform speech recognition on the speech instruction to obtain a corresponding instruction statement; and
decompose the instruction statement according to a first semantic feature corresponding to the instruction statement to obtain at least one instruction keyword in the instruction statement.

22. The electronic device according to claim 21, after decomposing the instruction statement to obtain the at least one instruction keyword in the instruction statement, the processor is further configured to: obtain a second semantic feature corresponding to the instruction keyword; and
obtain an approximate keyword corresponding to the instruction keyword based on the second semantic feature, wherein the approximate keyword is configured to perform the text recognition and/or the image recognition on the environment image to obtain the first recognition object and/or the second recognition object.

23. The electronic device according to claim 20, wherein the processor is further configured to: obtain a keyword category of the instruction keyword, the keyword category comprises at least a first category or a second category, the second semantic feature of the instruction keyword of the first category is represented by an image feature, and the second semantic feature of the instruction keyword of the second category is represented by a text feature;
when performing image recognition on the environment image based on the at least one instruction keyword to obtain the corresponding first recognition object, the processor is further configured to: perform the image recognition on the environment image based on at least one instruction keyword of the first category to obtain the corresponding first recognition object; and
when performing text recognition on the environment image based on the at least one instruction keyword to obtain the corresponding second recognition object, the processor is further configured to:
perform the text recognition on the environment image based on at least one instruction keyword of the second category to obtain the corresponding second recognition object.

24. The electronic device according to claim 17, wherein when detecting the environment image based on the first instruction to obtain the first recognition object and the second recognition object, the processor is further configured to: perform image detection on the environment image based on the first instruction to obtain the first recognition object;
perform, based on the first instruction, text detection for the first recognition object to obtain a text element within a first distance from the first recognition object; and
obtain the second recognition object according to the text element.

25. The electronic device according to claim 17, wherein when recognizing the first item with the first feature according to the first recognition object and the second recognition, the recognition module is further configured to: obtain first spatial coordinates corresponding to the first recognition object and second spatial coordinates corresponding to the second recognition object;
obtain a spatial distance between the first recognition object and the second recognition object according to the first spatial coordinates and the second spatial coordinates;
obtain a distance threshold corresponding to the first recognition object; and
determine, in response to that the spatial distance is lower than the distance threshold, a first position of the first item according to a position where the first recognition object is located.

26. The electronic device according to claim 25, wherein when obtaining the distance threshold corresponding to the first recognition object, the recognition module is further configured to:
obtain an outline size of the first recognition object, and/or an object category corresponding to the first recognition object; and
determine the distance threshold corresponding to the first recognition object based on the outline size and/or the object category.

27. The non-transitory computer-readable storage medium according to claim 18, wherein when detecting the environment image based on the first instruction to obtain the first recognition object and the second recognition object, the processor is further configured to:
obtain at least one instruction keyword according to the first instruction;
perform image recognition on the environment image based on the at least one instruction keyword to obtain the corresponding first recognition object; and
perform text recognition on the environment image based on the at least one instruction keyword to obtain the corresponding second recognition object.

28. The non-transitory computer-readable storage medium according to claim 18, wherein when detecting the environment image based on the first instruction to obtain the first recognition object and the second recognition object, the processor is further configured to:
perform image detection on the environment image based on the first instruction to obtain the first recognition object;
perform, based on the first instruction, text detection for the first recognition object to obtain a text element within a first distance from the first recognition object; and
obtain the second recognition object according to the text element.

29. The non-transitory computer-readable storage medium according to claim 18, wherein when recognizing the first item with the first feature according to the first recognition object and the second recognition, the recognition module is further configured to: obtain first spatial coordinates corresponding to the first recognition object and second spatial coordinates corresponding to the second recognition object;
obtain a spatial distance between the first recognition object and the second recognition object according to the first spatial coordinates and the second spatial coordinates;
obtain a distance threshold corresponding to the first recognition object; and
determine, in response to that the spatial distance is lower than the distance threshold, a first position of the first item according to a position where the first recognition object is located.
